(19) United States
(12) Patent Application Publication
(10) Pub. No.: US 2022/0227173 A1
(43) Pub. Date: Jul. 21, 2022

(54) Airless Wheel

(71) Applicant: Min Soo Kim, Incheon (KR)

(72) Inventors: Min Soo Kim, Incheon (KR); Kyung Hoon Kim, Gyeonggi-do (KR)

(21) Appl. No.: 17/616,488

(22) PCT Filed: Jun. 2, 2020
(86) PCT No.: PCT/KR2020/007138

§ 371 Date: Dec. 3, 2021

(30) Foreign Application Priority Data
Jun. 10, 2019 (KR) 10-2019-0067836

(51) Int. Cl. B60C 7/10

(52) U.S. Cl. CPC B60C 7/102; B60C 7/107

(57) ABSTRACT

An airless wheel that includes a hub of a constant diameter and having a shaft fitting hole, and an elastic wheel main body fixed to the periphery of the hub, and having a large number of integrated shock-absorbing spokes which pass and attenuate impact energy transmitted from a road surface during travel. In the airless wheel, the surface contacting the ground is capable of sufficient elastic deformation, and because a large number of shock-absorbing spokes are provided, the shock-absorbing action is made two-fold, making shocking-absorbing performance that much more favorable.

### FIELD OF THE INVENTION

The present disclosure relates to an airless wheel that does not need air injection and, more particularly, an airless wheel that can effectively attenuate shock that is transmitted up from the ground during driving.

### BACKGROUND OF THE INVENTION

Various types of wheels are used for vehicles, for example, including not only carriages, carts, or distribution robots for carrying objects at a warehouse or a supermarket, but the bed for a patient at a hospital. Wheels, which support the weight of an object to be moved and are configured to roll along a route, are designed to be able to absorb shock or vibration from a bumpy road surface as much as possible.

When vibration or shock that is transmitted from a road surface is not absorbed well, the driving ability is deteriorated, so it becomes difficult to operate a carriage, and particularly, as for a distribution robot, a problem such as damage to a precise part or separation of a sensor may be generated. Further, if severe, a wheel itself is damaged, so a problem that a wheel shaft is cut or deformed may be generated.

In order to solve these problems, various types of shock-absorbing devices employing a shock-absorbing technology for wheels have been developed. For example, a caster shock-absorbing device installed such that the middle portion of an arm having a wheel fixed at a side thereof is fixed by fixing a supporting bracket at a predetermined angle under a fixing plate having several fixing holes and a connection member is elongated and fixed to another side of the arm behind the supporting bracket has been disclosed in Korean Patent No. 10-0441165 (a caster shock absorbing structure). According to this patent, fastening grooves are formed at both sides of the rear end of the arm fixing the wheel so that a urethane cap can be fastened, and the urethane cap made of urethane is made shorter than a spring so that the spring and the urethane doubly absorb shock, depending on load. Further, an insertion portion is formed such that springs are inserted and seated at both sides therein for stable shock-absorbing, and the springs inserted in the insertion portion of the urethane cap is seated on seating protrusions formed at an end of the connecting member elongated behind the supporting bracket so that shock-absorbing of a caster is made by the urethane cap and the springs.

However, according to the shock-absorbing device, shock-absorbing members such as the spring and the urethane cap are provided between a wheel and a vehicle, so a shock-absorbing ability is not applied to a wheel itself. That is, the shock-absorbing device removes noise, which is generated by a vehicle during driving, and enables stable driving by attenuate shock that has passed through a wheel, rather than proposing a structure for a shock-absorbing ability of a wheel.

As a technology proposed to apply a shock-absorbing ability to a wheel itself in the related art, there is Korean Patent No. 10-1584340 (a non-pneumatic wheels and manufacturing method). The non-pneumatic wheel disclosed in the patent document is an airless wheel in which air is not forcibly injected, and has the structure shown in FIG. 1.

FIG. 1 is a cross-sectional view showing the internal structure of the non-pneumatic wheel.

As shown in the figure, a non-pneumatic wheel 10 of the related art is composed of an inner wheel 12 in which a shaft is fitted and an outer wheel 11 coupled to the circumferential edge of the inner wheel 12. Arc surfaces 12a are formed in two lines on the outer surface of the inner wheel 12. The arc surfaces 12a are provided to fix the outer wheel 11 and have a gap 12c therebetween. The gap 12c is a shock-absorbing space for receiving the outer wheel 11 in the direction of an arrow ‘a’ when shock is transmitted to the outer wheel 11.

However, the shock-absorbing effect of the non-pneumatic wheel 10 of the related art is not that high. This is because although the gap 12c is provided to absorb shock, the outer wheel 11 cannot be sufficiently inserted into the gap when shock is applied to the outer wheel 11. If the elastic strain of the outer wheel is small, the attenuation ability is naturally deteriorated.

### SUMMARY OF THE INVENTION

### Technical Problem

The present disclosure has been made in an effort to solve the problems and an objective of the present disclosure is to provide an airless wheel that has an excellent shock-absorbing ability because it can sufficiently elastically deform on the grounding surface and doubly performs shock-absorbing through several shock-absorbing spokes.

### Technical Solution

In order to achieve the objectives, an airless wheel of the present disclosure includes: a hub having a predetermined diameter and having a shaft hole; and an elastic wheel body having several integrated shock-absorbing spokes fixed to a circumferential edge of the hub and passing and attenuating shock energy that is transmitted from a road surface during driving.

The wheel body may be formed by performing insert injection molding on rubber with the hub fixed in a mold, and the shock-absorbing spokes may have a structure in which they are radially elongated and arranged with regular angles therebetween around a center of the hub.

The wheel body may be formed by performing insert injection molding on rubber with the hub fixed in a mold and may have several through-holes arranged with regular angles therebetween around a central axis of the shaft hole, and the shock-absorbing spokes may be positioned between adjacent through-holes.

The shock-absorbing spokes may be radially elongated from a center of the hub and may have a predetermined cross-sectional area in the extension direction.

A reinforcement ring having a predetermined diameter and supplementing structural strength of the wheel body may be embedded in the wheel body.

An outer surface of the wheel body may be a ground surface that comes in contact with a road surface in driving, and the reinforcement ring may be positioned between the shock-absorbing spokes and the grounding surface.

The reinforcement ring may have: a ring body having predetermined diameter and width; and several protruding blocks formed on an outer surface of the ring body, providing sealed shock-absorbing spaces between the wheel body and the protruding blocks, and spaced apart from each other with predetermined intervals therebetween in a circumferential direction of the ring body.

The protruding blocks may be arranged in parallel in two lines on the outer surface of the ring body, the shock-absorbing spaces may be shock-absorbing grooves formed between the protruding blocks, respectively, and the protruding blocks in one line of the two parallel lines of protruding blocks may be arranged to correspond to the shock-absorbing grooves in the other line.

The protruding blocks in two lines may be spaced apart in parallel with each other, and a second shock-absorbing groove elongated in the circumferential direction of the ring body and having a predetermined width may be further formed between the two lines.

An extension groove for increasing a contact area of the protruding block with the wheel body may be formed at the protruding block.

### Advantageous Effects

According to the airless wheel having this configuration of the present disclosure, since the grounding surface can be sufficiently elastically deformed and several shock-absorbing spokes are provided, shock-absorbing is doubly performed, so the shock-absorbing ability is excellent.

### BRIEF DESCRIPTION OF DRAWINGS

FIG. 1 is a cross-sectional view illustrating the problems of a non-pneumatic wheel that is an airless wheel of the related art;

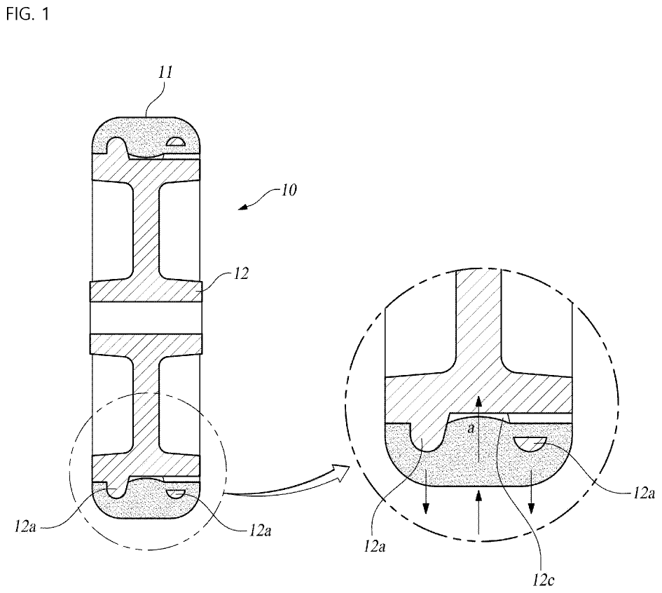

FIG. 2 is a perspective view of an airless wheel according to an embodiment of the present disclosure;

FIG. 3 is a cut perspective view of the airless wheel according to an embodiment of the present disclosure;

FIG. 4 is a view illustrating the structure of a reinforcement ring that can be disposed in the airless wheel according to an embodiment of the present disclosure;

FIGS. 5A to 5C are views illustrating a method of manufacturing the airless wheel shown in FIG. 2 for reference;

FIGS. 6A and 6B are cross-sectional views illustrating a shock-absorbing type of the airless wheel according to an embodiment of the present disclosure;

FIG. 7 is a perspective view showing another type of reinforcement ring that can be disposed in the airless wheel according to an embodiment of the present disclosure;

FIG. 8 is a cut perspective view of the airless wheel equipped with the reinforcement ring of FIG. 7 therein;

FIG. 9 is a partial cross-sectional view illustrating a method of manufacturing the airless wheel shown in FIG. 8 for reference;

FIGS. 10A and 10B are cross-sectional views illustrating a cross-sectional structure and a shock-absorbing type of the airless wheel shown in FIG. 8; and

FIG. 11 is a view showing the operation of shock-absorbing spokes of the airless wheel according to an embodiment of the present disclosure.

### DETAILED DESCRIPTION OF THE DRAWINGS

Basically, the airless wheel of the present disclosure is a wheel that absorbs shock using the elasticity of rubber rather than a tube type of injecting air, and shows an efficient shock-absorbing ability through double shock-absorbing.

The fundamental structure of the airless wheel includes: a hub having a predetermined diameter and having a shaft hole; and an elastic wheel body having several integrated shock-absorbing spokes fixed to the circumferential edge of the hub and passing and attenuating shock energy that is transmitted from a road surface during driving.

Hereinafter, one embodiment of the present disclosure is described in detail with reference to accompanying drawings.

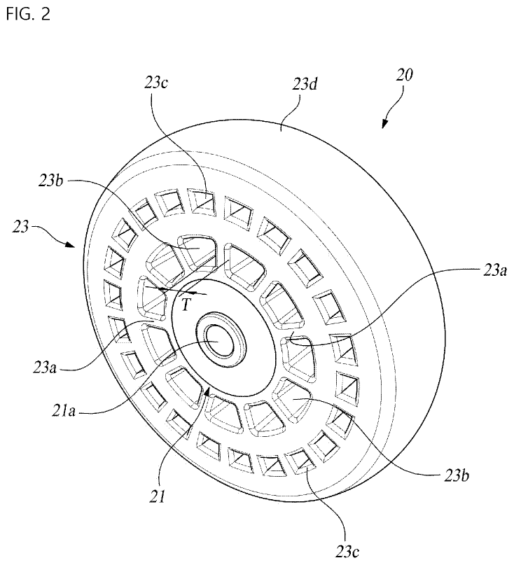

FIG. 2 is a perspective view showing the external appearance of an airless wheel 20 according to an embodiment of the present disclosure.

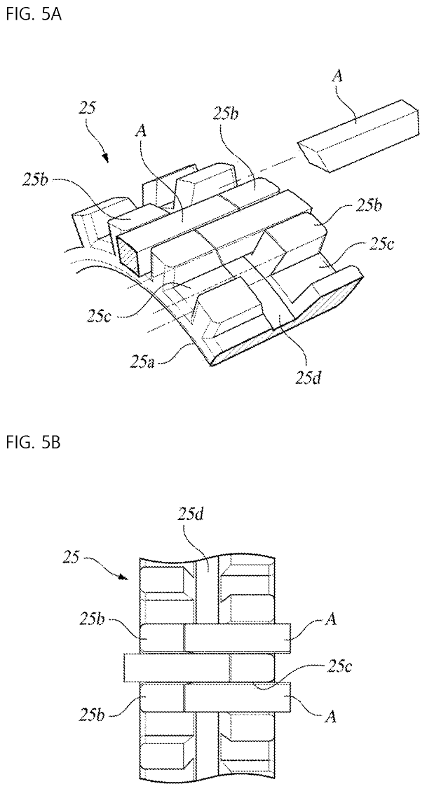

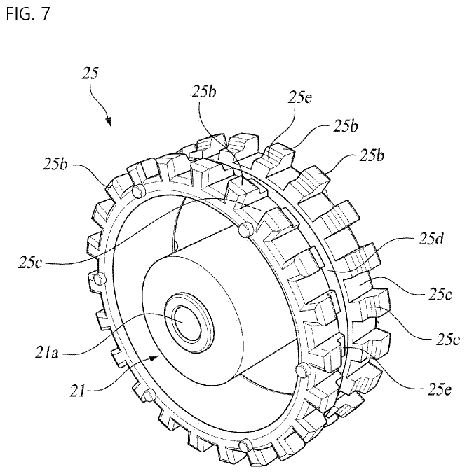

As shown in the figure, the airless wheel 20 according to the present embodiment includes a hub 21, a wheel body 23, and a reinforcement ring (25 in FIGS. 4 and 7) disposed in the wheel body 23.

The hub 21 is made of plastic through molding and has a shaft hole 21a at the center. A wheel shaft is fitted in the shaft hole 21a. The wheel body 23 is made of rubber or silicone through insert injection molding and has several shock-absorbing spokes 23a, through-holes 23b, and open holes 23c. The outer surface of the wheel body 23 is a grounding surface that comes in contact with a road surface G during driving.

The shock-absorbing spokes 23a, which are parts naturally formed by forming the through-holes 23b in the wheel body 23, each have a rectangular cross-section in the radial direction. The reason of forming the through-holes 23b in insert injection molding is for decreasing the weight of the entire airless wheel 20, reducing the materials to be used, and forming the shock-absorbing spokes 23a.

The through-holes 23b are holes formed in the thickness direction of the airless wheel 20. The thickness direction is the direction of the wheel shaft that is fitted in the shaft hole 21a.

The through-holes 23b each have a fan shape or a trapezoidal shape and are arranged with regular angles therebetween around the central axis of the shaft hole 21a. Since through-holes are formed in the type described above, the shock-absorbing spokes 23a having a predetermined thickness T are obtained.

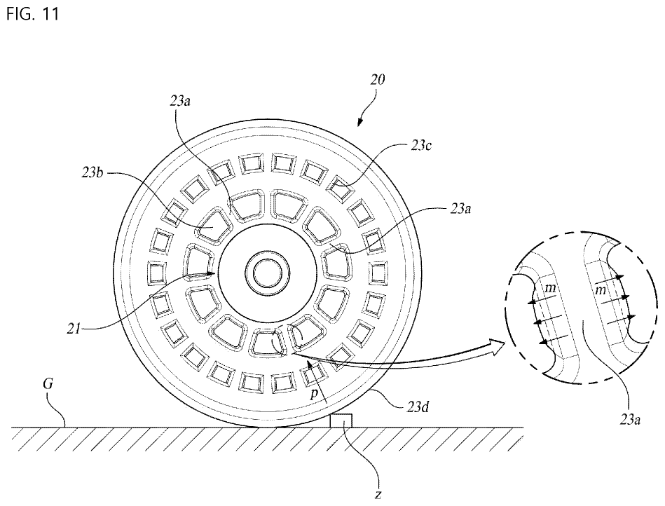

The shock-absorbing spokes 23a, as shown in FIG. 11, serve to absorb shock energy that is, for example, generated at the moment when the airless wheel 20 goes over an obstacle Z while rolling on a road surface. That is, the shock-absorbing spokes 23a attenuate energy by elastically deforming at the moment when shock energy is transmitted. It is natural that an energy attenuation ratio depends on the thickness of the shock-absorbing spokes 23a. The thickness of the shock-absorbing spokes 23a is appropriately designed in consideration of the use environment of the airless wheel 20.

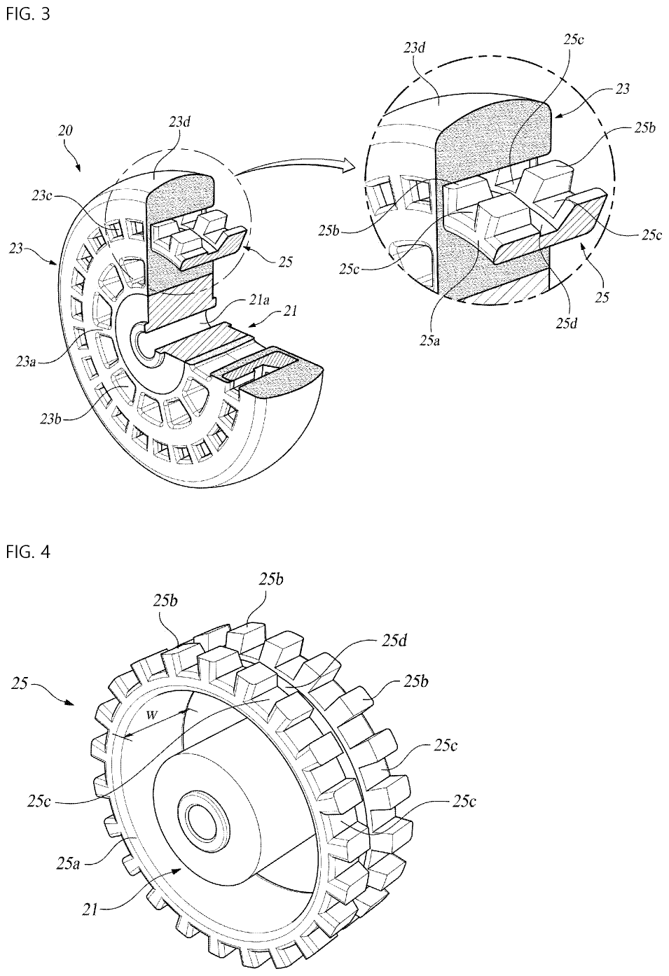

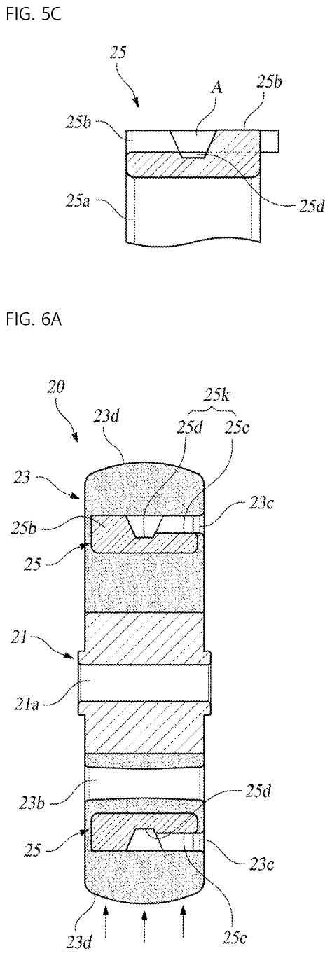

The open holes 23c are holes formed by molding pins A that are inserted in first shock-absorbing grooves (25c in FIG. 3C) in injection molding and pulled out after injection molding. That is, the open holes 23c are the places where the molding pin A were. This will be described below with reference to FIGS. 5A to 5C.

A reinforcement ring 25 is disposed in the wheel body 23. The reinforcement ring 25 is a ring-shaped member having the shape shown in FIG. 4 or 7.

FIG. 3 is a cut perspective view of the airless wheel 20 according to an embodiment of the present disclosure, in which the reinforcement ring 25 is separately shown.

The reinforcement ring 25 is embedded between the shock-absorbing spokes 23a and the grounding surface 23d and serves to supplement the structural strength of the wheel body 23. The reinforcement ring 25 have a ring body 25a and several protruding blocks 25b integrally formed on the outer surface of the ring body 25a.

The ring body 25a, which is a ring-shaped member having predetermined diameter and width S, is coaxially disposed with the shaft hole 21a. A second shock-absorbing groove 25d is formed on the outer surface of the ring body 25a. The second shock-absorbing groove 25d is a groove formed at the center in the width direction of the ring body 25a and having predetermined width and depth.

The protruding blocks 25b are formed at the left and right sides of the second shock-absorbing groove 25d. The protruding blocks 25b, which are hexahedral members integrally formed on the outer surface of the ring body 25a, are circumferentially arranged with regular intervals on the ring body 25a. The spaces between the protruding blocks 25b are empty without being filled with rubber or silicone as first shock-absorbing grooves 25c and are laterally open through the open holes 23c.

The line of the protruding blocks 25b arranged at the right side and the line of the protruding blocks 25b arranged at the right side with the second shock-absorbing groove 25d therebetween, that is, the left line and the right line are parallel with each other, that is, are spaced apart in parallel with each other with the second shock-absorbing groove 25d therebetween. The protruding blocks 25b are arranged in two lines in parallel with each other on the outer surface of the ring body 25a.

In particular, the protruding blocks 25b in one line of the two parallel lines of protruding blocks correspond one to one to the first shock-absorbing grooves 25c in the other line. That is, the protruding blocks 25b in the left line correspond to the first shock-absorbing grooves 25d in the right line and the first shock-absorbing grooves 25d in the left line correspond to the protruding blocks 25b in the right line. In other words, the protruding blocks in the right line are arranged to be biased by a half pitch with respect to the protruding blocks in the left line.

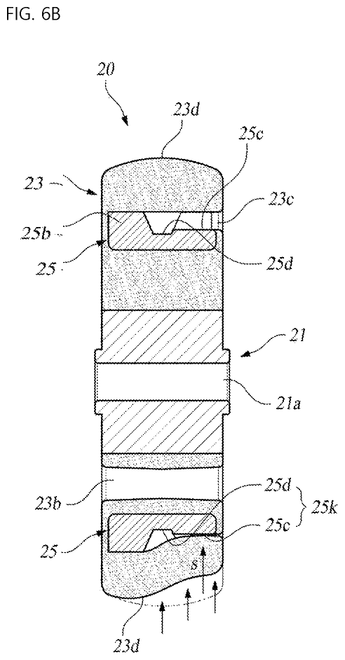

The reason of forming the protruding blocks 25b in the type described above is for forming shock-absorbing spaces 25k outside the reinforcement ring 25. The shock-absorbing spaces 25 are the first shock-absorbing grooves 25c and the second shock-absorbing groove 25d and enable the wheel body 23 to be sufficiently elastically deformed when shock is transmitted while the airless wheel 20 rolls. That is, as shown in FIG. 6B, the wheel body 23 is enabled to be elastically deformed by a desired amount in the direction of arrows s.

The reason that the first shock-absorbing grooves 25 or the second shock-absorbing groove 25d is not filled with rubber or silicone even through insert injection molding is performed on rubber or silicone with the reinforcement ring 25 installed in a mold depends on the type of insert injection molding.

FIGS. 5A to 5C are views illustrating an injection molding method of manufacturing the airless wheel 20 shown in FIG. 2 for reference.

In order to manufacture the airless wheel 20, an insert injection mold (not shown) having several molding pins A should be prepared. When an insert injection mold is prepared, the insert injection mold is opened, and the hub 21 and the reinforcement ring 25 are placed at predetermined positions therein.

When the hub 21 and the reinforcement ring 25 are placed at the predetermined positions, the insert injection mold is closed and the molding pins A are inserted into the first shock-absorbing grooves 25c to come in contact with the opposite protruding blocks 25b across the second shock-absorbing groove 25d. The molding pins A stand by while filling all the first shock-absorbing grooves 25c and covering the second shock-absorbing grooves 25d.

In this state, prepared fluid rubber is injected into the mold, whereby the external appearance of the wheel body 23 is formed. After the rubber is cooled, the insert injection mold is opened. As the insert injection mold is opened, the molding pins A are separated from the reinforcement ring 25 with the first and second shock-absorbing grooves 25c and 25d and the open holes 23c left in the wheel body 23.

FIGS. 6A and 6B are cross-sectional views illustrating a shock-absorbing type of the airless wheel 20 according to an embodiment of the present disclosure.

As shown in the figures, the reinforcement ring 25 is embedded in the wheel body 23 of the airless wheel 20. The reinforcement ring 25 serves to supplement the structural strength of the airless wheel 20, and particularly has the first and second shock-absorbing grooves 25c and 25d on the circumferential edge.

The first and second shock-absorbing grooves 25c and 25d provide a space that enables the wheel body 23 to be deformed in the direction of arrows s by shock transmitted from a road surface during driving. If the first and second shock-absorbing grooves 25c and 25d are not provided, that is, there is no space that enables the wheel body to retract in the direction of arrows s, the wheel body contracts only a little within the elastic limit of the rubber itself, so the shock attenuation efficiency is not that high.

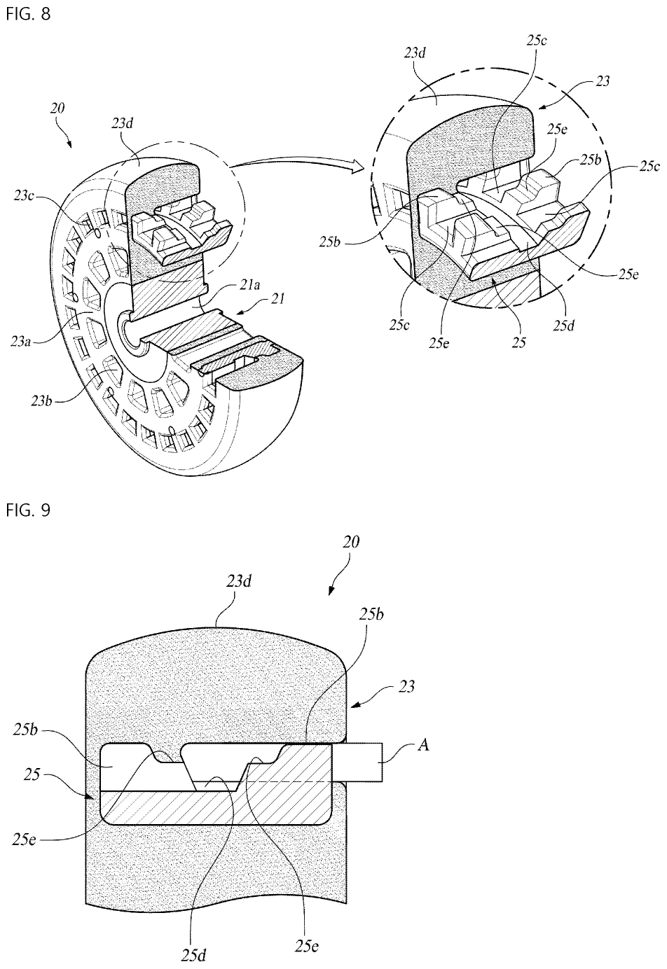

FIG. 7 is a perspective view showing another type of reinforcement ring that can be disposed in the airless wheel according to an embodiment of the present disclosure and FIG. 8 is a cut perspective view of the airless wheel equipped with the reinforcement ring of FIG. 7 therein.

Hereafter, the same members having the same functions are indicated by the same reference numerals as those described above.

Referring to the figures, it can be seen that an extension groove 25e is formed at a portion of each of the protruding blocks 25b. The extension groove 25d serves to increase the contact area of the protruding block 25b with the rubber or silicone of the wheel body 23. As shown in FIG. 8, a portion of the wheel body 23 is inserted in the extension grooves 25e. Since the contact area of the wheel body 23 with the protruding blocks 25b is increased, the portion covering the outer portion of the reinforcement ring 25 keeps more stably coupled to the reinforcement ring 25, so smoothness of driving is improved.

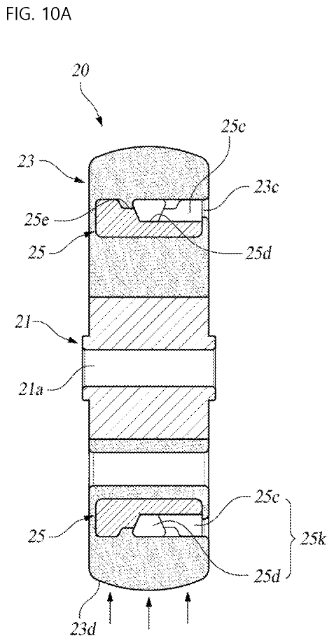

FIG. 9 is a partial cross-sectional view illustrating a method of manufacturing the airless wheel 20 shown in FIG. 8 for reference;

As shown in FIG. 9, the extension groove 25e is positioned ahead of the front end of the molding pin A fully inserted through the first shock-absorbing groove 25c. The extension groove 25e is filled with rubber of the wheel body 23.

Since the extension groove 25e is further formed at the protruding block 25b in this way, the area that prevents elastic deformation in the direction of arrows s of the wheel body 23, that is, the area of the horizontal surface of the protruding block 25 is decreased, so elastic deformation can be more easily made.

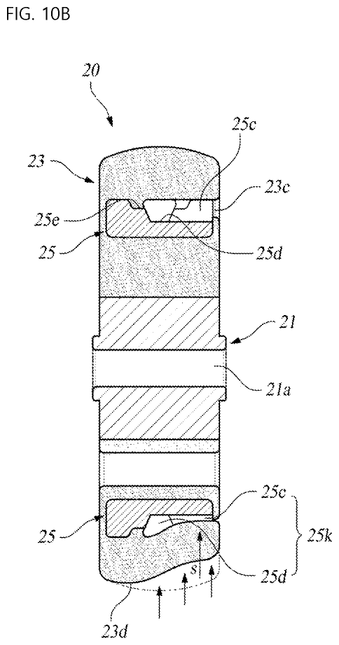

FIGS. 10A and 10B are cross-sectional views illustrating a cross-sectional structure and a shock-absorbing type of the airless wheel shown in FIG. 8.

Referring to FIG. 10A, it can be seen that the extension grooves 25e are filled with the rubber of the wheel body 23 and the shock-absorbing spaces 25k are empty and laterally open through the open holes 23c.

When shock is applied in the direction of arrows s to the airless wheel 20 having the configuration described above while the airless wheel 20 rolls on a road surface, as shown in FIG. 10B, the corresponding portion is elastically deformed and moved into the first and second shock-absorbing grooves 25c and 25d. The fact that the outer portion of the wheel body 23 is easily deformed in the direction of arrows s, as described above, means that the shock-absorbing efficiency is high.

FIG. 11 is a view showing the shock-absorbing operation of the airless wheel according to an embodiment of the present disclosure.

As shown in the figure, when the airless wheel 20 rolling on a road surface G comes across an obstacle Z and receives shock in the direction of an arrow P, a portion of the wheel body 23 is elastically deformed in the direction of arrows s, as shown in FIGS. 6 and 10, whereby it is instantaneously inserted into the shock-absorbing spaces 25k. Accordingly, shock energy is primarily attenuated.

Further, the remaining shock energy is transmitted to the shock-absorbing spokes 23a, whereby it is removed. The shock-absorbing spokes 23a, so to speak, secondarily attenuate shock energy by elastically deforming in the direction of arrows m.

As a result, the airless wheel 20 having the above configuration of the present disclosure attenuates shock through two steps, and particularly, physical elastic deformation of the wheel body 23 is sufficiently made, so the efficiency of attenuating shock energy is high.

Although the present disclosure was described in detail through a detailed embodiment, the present disclosure is not limited thereto and may be modified in various ways by those skilled in the art without departing from the spirit of the present disclosure.

1. An airless wheel comprises:
a hub having a predetermined diameter and having a shaft hole; and
an elastic wheel body having several integrated shock-absorbing spokes fixed to a circumferential edge of the hub and passing and attenuating shock energy that is transmitted from a road surface during driving.

2. The airless wheel of claim 1, wherein the wheel body is formed by performing insert injection molding on rubber with the hub fixed in a mold, and
the shock-absorbing spokes are radially elongated and arranged with regular angles therebetween around a center of the hub.

3. The airless wheel of claim 1, wherein the wheel body is formed by performing insert injection molding on rubber with the hub fixed in a mold and has several through-holes arranged with regular angles therebetween around a central axis of the shaft hole, and
the shock-absorbing spokes are positioned between adjacent through-holes.

4. The airless wheel of claim 3, wherein the shock-absorbing spokes are radially elongated from a center of the hub and have a predetermined cross-sectional area in the extension direction.

5. The airless wheel of claim 2, wherein a reinforcement ring having a predetermined diameter and supplementing structural strength of the wheel body is embedded in the wheel body.

6. The airless wheel of claim 5, wherein an outer surface of the wheel body is a ground surface that comes in contact with a road surface in driving, and the reinforcement ring is positioned between the shock-absorbing spokes and the grounding surface.

7. The airless wheel of claim 5, wherein the reinforcement ring has:
a ring body having predetermined diameter and width; and
several protruding blocks formed on an outer surface of the ring body, providing sealed shock-absorbing spaces between the wheel body and the protruding blocks, and spaced apart from each other with predetermined intervals therebetween in a circumferential direction of the ring body.

8. The airless wheel of claim 7, wherein the protruding blocks are arranged in parallel in two line on the outer surface of the ring body, and the shock-absorbing spaces are shock-absorbing grooves formed between the protruding blocks, respectively.

9. The airless wheel of claim 8, wherein the protruding blocks in one line of the two parallel lines of protruding blocks are arranged to correspond to the shock-absorbing grooves in the other line.

10. The airless wheel of claim 8, wherein the protruding blocks in two lines are spaced apart in parallel with each other, and a second shock-absorbing groove elongated in the circumferential direction of the ring body and having a predetermined width is further formed between the two lines.

11. The airless wheel of claim 7, wherein an extension groove for increasing a contact area of the protruding block with the wheel body is formed at the protruding block.

12. The airless wheel of claim 3, wherein a reinforcement ring having a predetermined diameter and supplementing structural strength of the wheel body is embedded in the wheel body.

13. The airless wheel of claim 4, wherein a reinforcement ring having a predetermined diameter and supplementing structural strength of the wheel body is embedded in the wheel body.
